(19) United States
(12) Patent Application Publication
(10) Pub. No.: US 2012/0242280 A1
(43) Pub. Date: Sep. 27, 2012

(54) POWER SUPPLY FOR BOOSTING CHARGE

(76) Inventors: Yong Sug SUH, Cheollabuk-do (KR); Dae Gyun KIM, Gyeonggi-do (KR); Wang Byuck SUH, Gyeonggi-do (KR)

(21) Appl. No.: 13/298,040

(22) Filed: Nov. 16, 2011

(30) Foreign Application Priority Data
Mar. 21, 2011 (KR) 10-2011-0024900

(51) Int. Cl. H02J 7/00

(52) U.S. Cl. 320/107

(57) ABSTRACT

Provide is a power supply for boosting charge which is adaptive to a change in capacity by modularizing each part, can achieve modularization while facilitating insulation from a grid by installing a transformer at the grid side, can reduce the ripple of the output current by controlling a switching in a phase staggering scheme, and can reduce the ripple of the output current in an individual charging mode. The power supply for boosting charge includes: an input filter unit for filtering current or voltage introduced from a power grid; a rectifying unit for rectifying an AC voltage outputted from the input filter unit into a DC voltage; a DC link unit for smoothing an output voltage of the rectifying unit; and a battery charging unit which includes two or more battery charging modules connected in parallel to the DC link unit.

### CROSS-REFERENCE TO RELATED APPLICATION

The present application claims the benefit under 35 U.S.C. §119(a) to Korean patent application No. 10-2011-0024900, filed on Mar. 21, 2011, the disclosure of which is expressly incorporated by reference herein in its entirety.

### BACKGROUND OF THE INVENTION

1. Field of the Invention

The present invention relates to a power supply for boosting charge, and more particularly, to a power supply for boosting charge of a battery which is mounted on an electric vehicle or hybrid vehicle.

2. Description of the Related Art

The conventional battery charging devices are classified into an insulated DC-DC converter of FIG. 1 and a non-insulated DC-DC converter of FIG. 2.

The insulated DC-DC converter has a low-frequency transformer or a high-frequency transformer at the center thereof, and provided at the primary side thereof with a half-bridge converter or a full-bridge converter. Such an insulated DC-DC converter is easily insulated due to the transformer. However, since requiring a transformer, the insulated DC-DC converter is heavy, is difficult to be modularized, requires the turns ratio of the transformer to be adjusted upon a change in capacity, generates a high turn-off spike at a primary-side switch due to the leakage inductance of the transformer, and requires a plurality of elements.

Meanwhile, the non-insulated DC-DC converter is simple in structure, can achieve high efficiency, high reliability, and low price because voltage is adjusted by the on/off ratio of a switch, and is easy to be modularized. However, the non-insulated DC-DC converter has advantages in that an input side and an output side are electrically connected to each other, and the filter size of capacitor and inductor increases in order to reduce the voltage and current ripples of the output side.

### SUMMARY OF THE INVENTION

Accordingly, the present invention has been made in an effort to solve the problems occurring in the related art, and an object of the present invention is to provide a power supply for boosting charge, each part of which is modularized to be adaptive to a change in capacity.

In addition, another object of the present invention is to provide a power supply for boosting charge which is provided at a grid side thereof with a transformer so as to be able to achieve modularization and simultaneously to facilitate insulation from the grid.

In addition, still another object of the present invention is to provide a power supply for boosting charge, the switching of which is controlled in a phase staggering scheme so as to be able to reduce the ripple of the output current.

In addition, still another object of the present invention is to provide a power supply for boosting charge, the switching of which is controlled in a phase staggering scheme so as to be able to reduce the ripple of the output current in an individual charging mode.

In order to achieve the above object, according to one aspect of the present invention, there is provided a power supply for boosting charge including: an input filter unit configured to filter current or voltage introduced from a power grid; a rectifying unit configured to rectify an alternating current (AC) voltage outputted from the input filter unit into a direct current (DC) voltage; a DC link unit configured to smooth an output voltage of the rectifying unit; and a battery charging unit which includes two or more charging modules connected in parallel to the DC link unit.

The power supply further includes a transformer installed at an input terminal of the input filter unit.

The battery charging module includes a plurality of switching elements connected in parallel with each other, and the plurality of switching elements are alternately switched.

The battery charging unit performs a charging operation in different modes depending on a charged state of a battery unit.

The battery charging unit performs the charging operation in a precharge mode when the charged voltage of the battery unit is equal to or less than a first level, in a constant current mode when the charged voltage of the battery unit exceeds the first level and is equal to or less than a second level, and in a constant voltage mode when the charged voltage of the battery unit exceeds the second level.

In the precharge mode, any one of the plurality of battery charging modules in the battery charging unit operates.

Switching elements of a plurality of battery charging modules in the battery charging unit are alternately turned on for an equal period of time within one cycle.

The battery charging module corresponds to a bidirectional converter which can charge a battery unit from the DC link unit and discharge the battery unit to the DC link unit.

### BRIEF DESCRIPTION OF THE DRAWINGS

The above objects, and other features and advantages of the present invention will become more apparent after a reading of the following detailed description taken in conjunction with the drawings, in which:

FIG. 1 is a view illustrating the topology of a conventional insulated DC-DC converter;

FIG. 2 is a view illustrating the topology of a conventional non-insulated DC-DC converter;

FIG. 3 is a block diagram illustrating the entire configuration of a power supply for boosting charge according to an embodiment of the present invention;

FIG. 4 is a view illustrating the topology of a battery charging unit which uses a two-step bidirectional converter according to an embodiment of the present invention;

FIG. 5 is a waveform view of output current when the two-step bidirectional converter according to an embodiment of the present invention is used;

FIG. 6 is a waveform view of output current when one-step bidirectional converter is used according to a comparative embodiment of the present invention;

FIG. 7 is a view illustrating the topology of a battery charging unit which uses a three-step bidirectional converter according to another embodiment of the present invention;

FIG. 8 is a waveform view of current when the three-step bidirectional converter according to another embodiment of the present invention is used;

FIG. 9 is a waveform view of step-waveform charging current in a precharge mode according to an embodiment of the present invention;

FIG. 10 is a waveform view of charging current of a low current type having a predetermined level in a precharge mode according to an embodiment of the present invention;

FIG. 11 is a waveform view of pulse-waveform charging current in a precharge mode according to an embodiment of the present invention;

FIG. 12 is a waveform of DC-link output current and voltage in the precharge mode of one-step battery charging module according to an embodiment of the present invention;

FIG. 13 is a waveform of DC-link output current and voltage in the precharge mode of three-step battery charging modules according to another embodiment of the present invention;

FIG. 14 is a waveform of DC-link output current and voltage in the constant current mode of one-step battery charging module according to an embodiment of the present invention;

FIG. 15 is a waveform of DC-link output current and voltage in the constant current mode of three-step battery charging modules according to another embodiment of the present invention;

FIG. 16 is a waveform of DC-link output current and voltage in the constant voltage mode of one-step battery charging module according to an embodiment of the present invention;

FIG. 17 is a waveform of DC-link output current and voltage in the constant voltage mode of three-step battery charging modules according to another embodiment of the present invention;

FIG. 18 is a waveform of DC-link output current and voltage in a discharging mode of one-step battery charging module according to an embodiment of the present invention;

FIG. 19 is a waveform of DC-link output current and voltage in the discharging mode of three-step battery charging modules according to another embodiment of the present invention; and

FIG. 20 is a block diagram illustrating the entire configuration of a power supply for boosting charge according to another embodiment of the present invention.

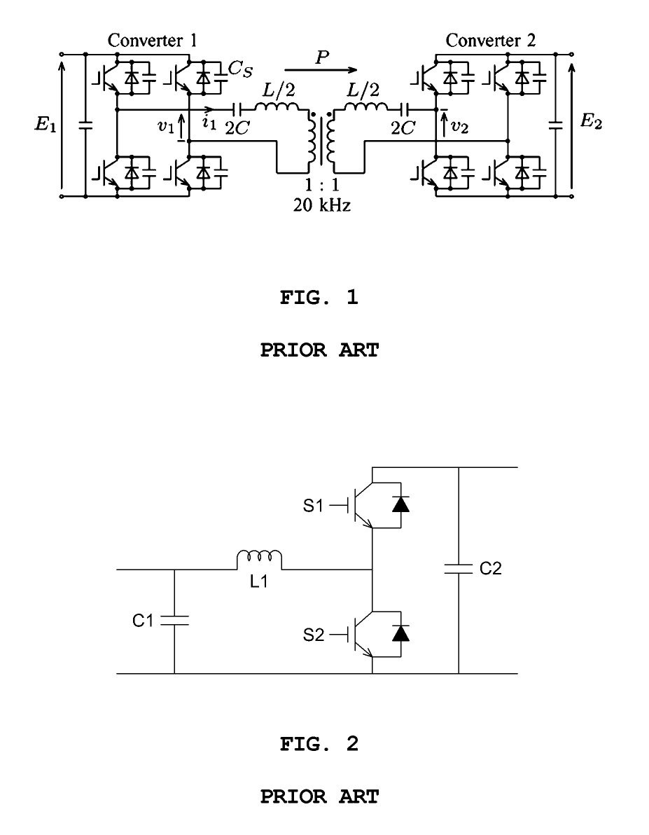

### DETAILED DESCRIPTION OF PREFERRED EMBODIMENTS

Reference will now be made in greater detail to preferred embodiments of the invention, examples of which are illustrated in the accompanying drawings. Wherever possible, the same reference numerals will be used throughout the drawings and the description to refer to the same or like parts. First of all, terms and words used in the specification and the claims should be interpreted not in a limited normal or dictionary meaning, but to include meanings and concepts conforming with technical aspects of the present invention, based on the face that inventors may appropriately define a concept of a term to describe his/her own invention in a best way. Therefore, the configurations described in the specification and drawn in the figures are just exemplary embodiments of the present invention, not to show all of the technical aspects of the present invention. So, it should be understood that there might be various equalities and modifications to be replaced with them.

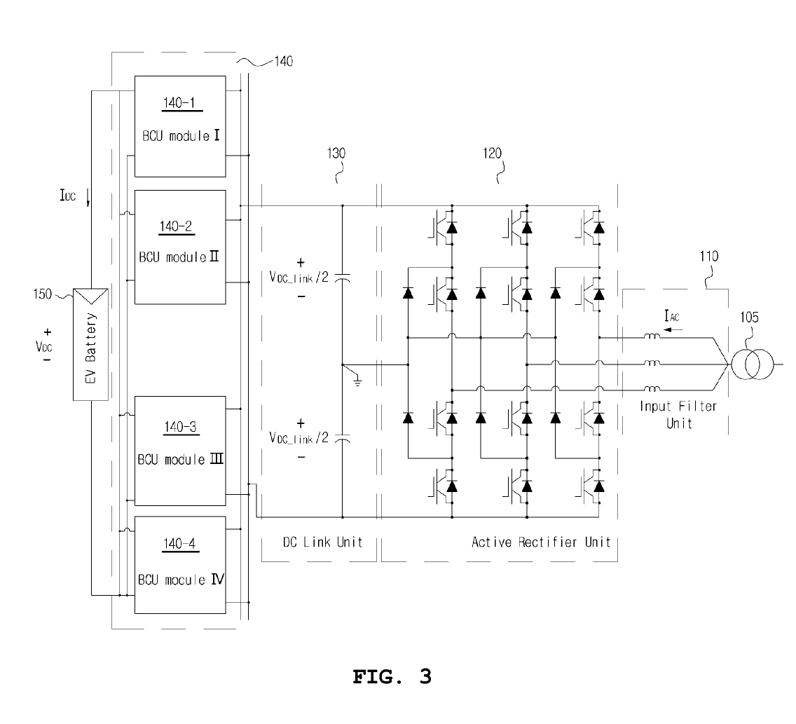

FIG. 3 is a block diagram illustrating the entire configuration of a power supply for boosting charge according to an embodiment of the present invention.

According to an embodiment of the present invention, the power supply for boosting charge includes an input filter unit 110, an active rectifier unit 120, a DC link unit 130, a battery charging unit 140, and a battery unit 150.

The input filter unit 110 is connected to the secondary side of a transformer 105 which is connected with a grid, and filters the output of the transformer 105. For example, a reactor connected to each phase reduces the ripple of input current.

The active rectifier unit 120 includes a plurality of switching elements connected with the output terminal of the input filter unit 110, and rectifies an alternating current (AC) voltage outputted from the input filter unit 110 into a direct current (DC) voltage by switching the plurality of switching elements on and off in various patterns.

The DC link unit 130 includes a capacitor connected in parallel with the active rectifier unit 120, and smoothes the output voltage of the active rectifier unit 120.

The battery charging unit 140 includes two or more battery charging modules connected in parallel with the DC link unit 130, and performs a charging operation in different modes depending on the charged state of the battery unit 150. The battery charging modules are bidirectional converters, which can charge the battery unit 150 from the DC link unit 130, and can discharge the battery unit 150 to the DC link unit 130.

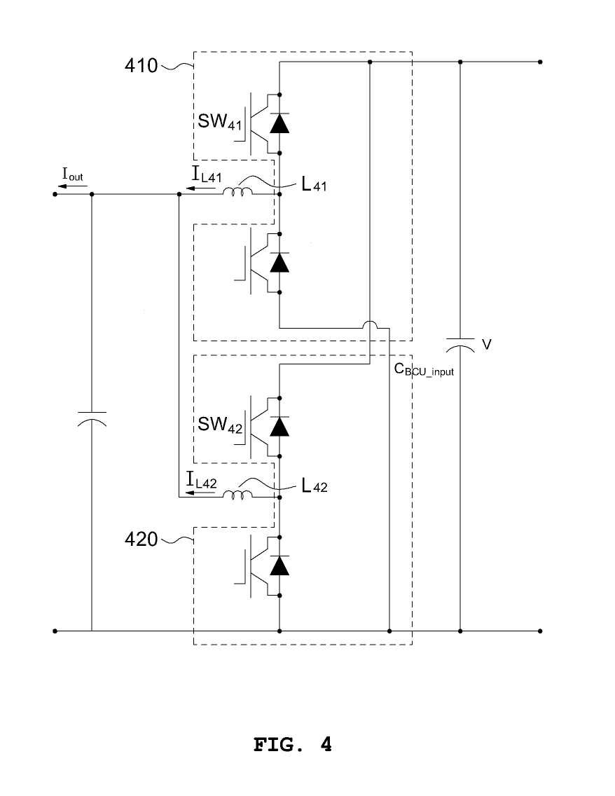

FIG. 4 is a view illustrating the topology of a battery charging unit which uses a two-step bidirectional converter according to an embodiment of the present invention.

According to an embodiment of the present invention, the battery charging unit includes two bidirectional converters 410 and 420 connected in parallel with each other, and alternately turns on a first switch SW41 and a second switch SW42 within one cycle. For example, each of the first switch SW41 and second switch SW42 may be turned on for T/2 in one cycle “T”.

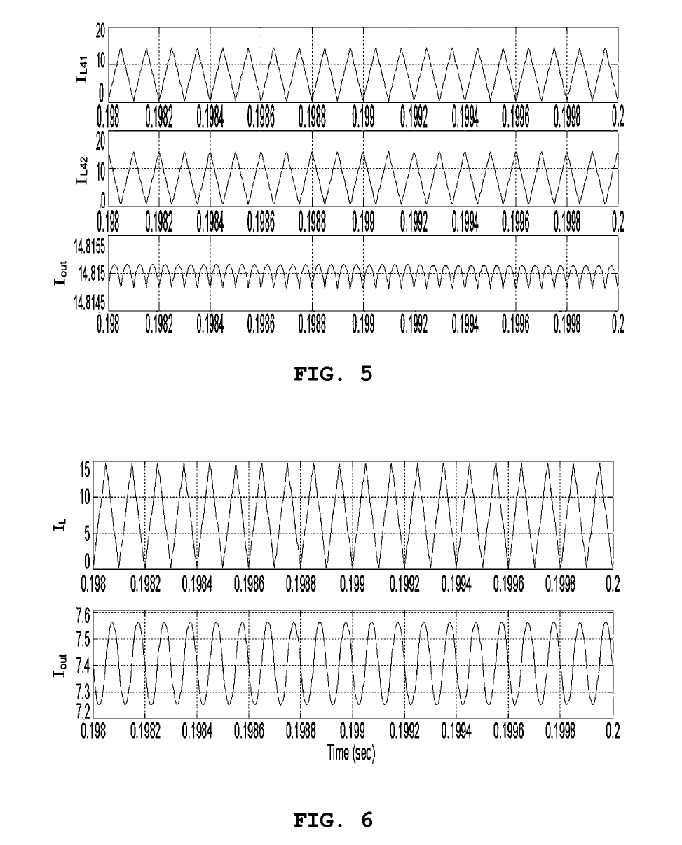

FIG. 5 is a waveform view of output current when the two-step bidirectional converter according to an embodiment of the present invention is used. When the first switch SW41 and second switch SW42 of the two bidirectional converters 410 and 420 are alternately turned on, current IL41 and IL42 flowing through two reactors have a phase difference of 180 degrees, and a harmonic component is offset to reduce the ripple component of the output current.

FIG. 6 is a waveform view of output current when one-step bidirectional converter is used according to a comparative embodiment of the present invention, wherein when one bidirectional converter is switched on, reactor current IL and the output current Iout have ripple components with significant magnitudes.

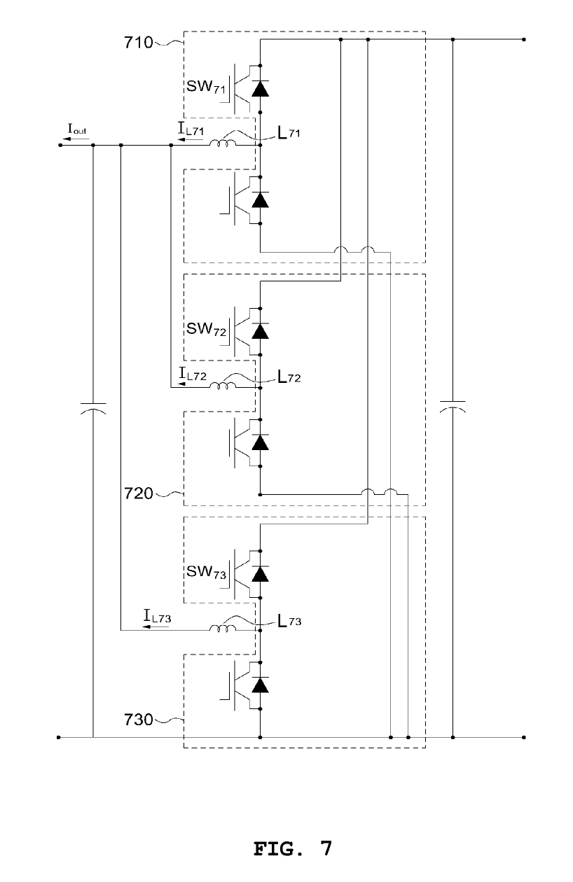

FIG. 7 is a view illustrating the topology of a battery charging unit which uses a three-step bidirectional converter according to another embodiment of the present invention.

According to another embodiment of the present invention, the battery charging unit includes three bidirectional converters 710, 720, and 730 connected in parallel with each other, and turns on a first switch SW71, a second switch SW72, and a third switch SW73 in regular sequence within one cycle. For example, each of the first switch SW71, second switch SW72, and third switch SW73 may be turned on for T/3 in one cycle “T”.

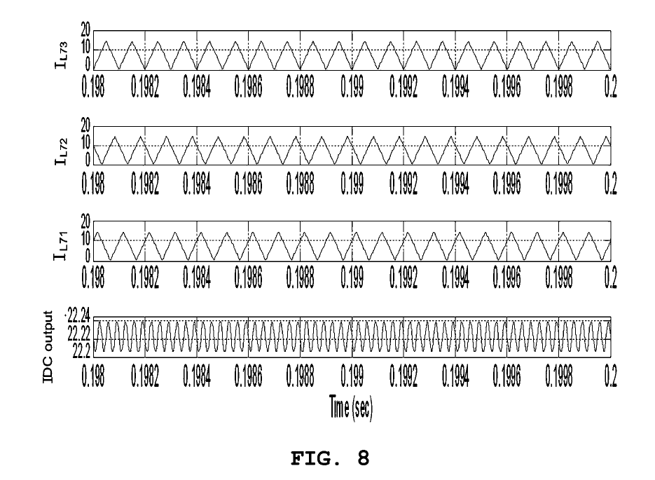

FIG. 8 is a waveform view of current when the three-step bidirectional converter according to another embodiment of the present invention is used. When the first switch SW71 to third switch SW73 of the three bidirectional converters 710, 720, and 730 are turned on in regular sequence, current IL71, IL72, and IL73 flowing through three reactors have a phase difference of 120 degrees, and a harmonic component is offset to significantly reduce the ripple component of the output current.

Meanwhile, the power supply for boosting charge according to an embodiment of the present invention operates in a precharge mode, a constant current mode, and a constant voltage mode according to the level of the battery voltage.

For example, in the case of a battery of which the maximum charging voltage is 4.2 volts per cell, the power supply operates in the precharge mode, in which low charging current flows, when the battery voltage is equal to or less than 2.7 volts; operates in the constant current mode, in which constant charging current flows, when the battery voltage has a value within a range from 2.7 volts to 4.1 volts; and operates in the constant voltage mode, in which changing current is gradually reduced while a charging voltage is constantly maintained, when the battery voltage is equal to or greater than 4.1 volts. Here, in each charging mode, it is possible to reduce ripple current by alternately switching the switches of bidirectional converters.

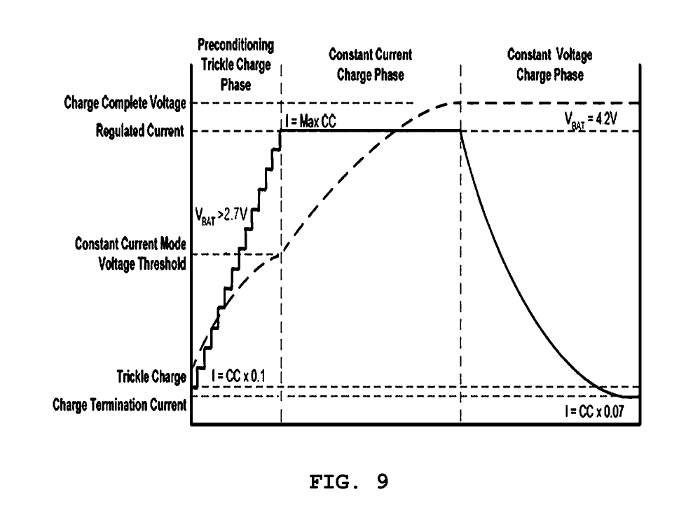

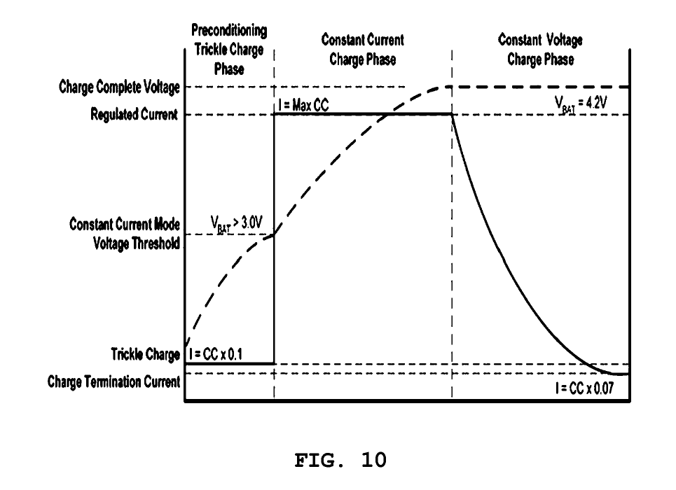

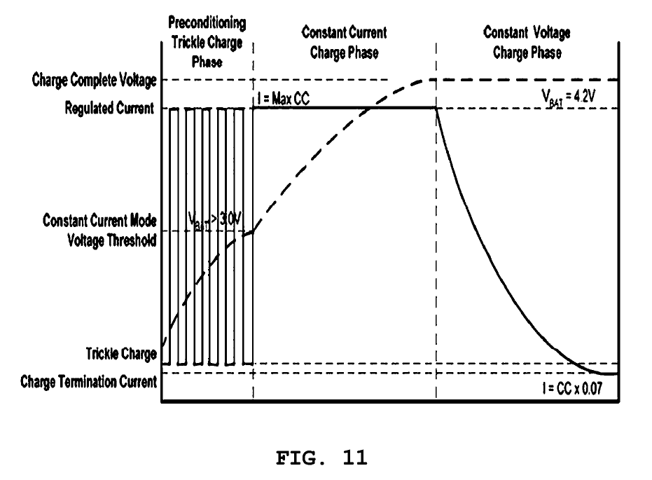

In addition, in the precharge mode, the battery charging unit 140 may control charging current with a step waveform (see FIG. 9), with low current of a predetermined level (see FIG. 10), or with a pulse waveform (see FIG. 11).

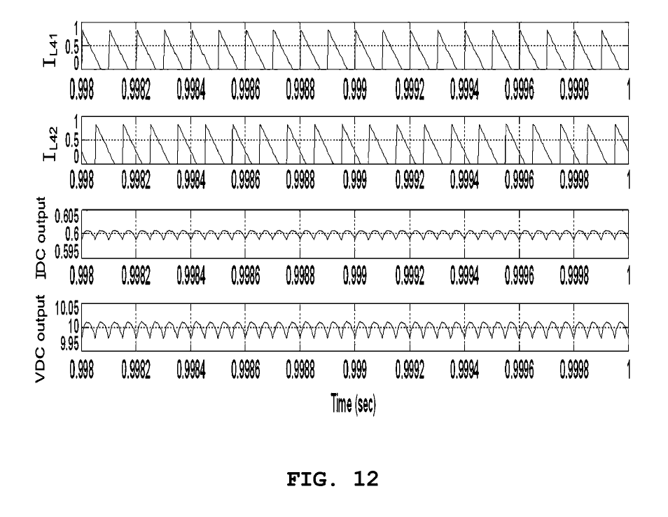

FIG. 12 is a waveform of DC-link output current and voltage in the precharge mode of one-step battery charging module according to an embodiment of the present invention. It can be confirmed that, in the case where the battery charging unit 140 shown in FIG. 3 is constituted by one-step battery charging module, when the first switch SW41 and second switch SW42 in the two bidirectional converters 410 and 420 shown in FIG. 4 are alternately turned on in the precharge mode, current IL41 and IL42 flowing through two reactors in the precharge mode has a phase difference of 180 degrees, and the ripple components of DC output current “IDC output” and DC output voltage “VDC output” are reduced even in the precharge mode.

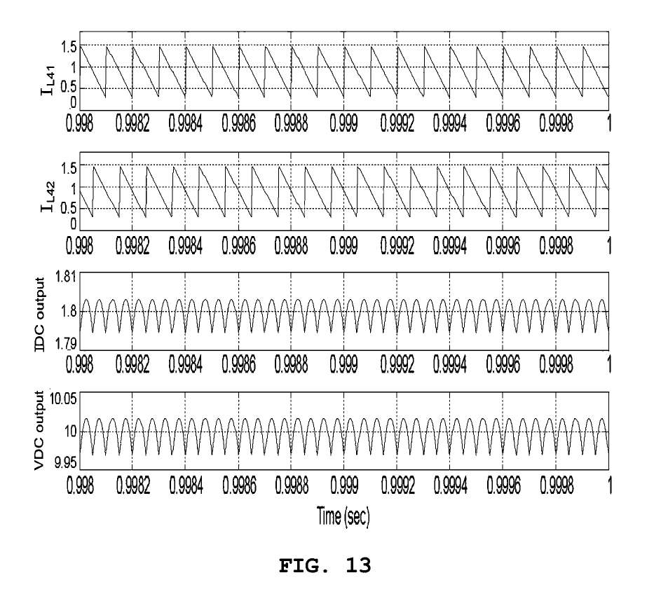

FIG. 13 is a waveform of DC-link output current and voltage in the precharge mode of three-step battery charging modules according to another embodiment of the present invention. When the battery charging unit 140 shown in FIG. 3 is constituted by three-step battery charging modules, the precharge mode requires only one-step battery charging module to be used. Therefore, when two individual switches in the one-step battery charging module are alternately turned on, e.g. when the first switch SW41 and second switch SW42 are alternately turned on in the precharge mode, reactor current IL41 and IL42 has a phase difference of 180 degrees, and the ripple components of compound DC output current “IDC output” and DC output voltage “VDC output” are reduced.

In addition, according to an embodiment of the present invention, three-step battery charging modules operate for the predetermined period of time in regular sequence in the precharge mode, so that it is possible to prevent one specific battery charging module from being deteriorated.

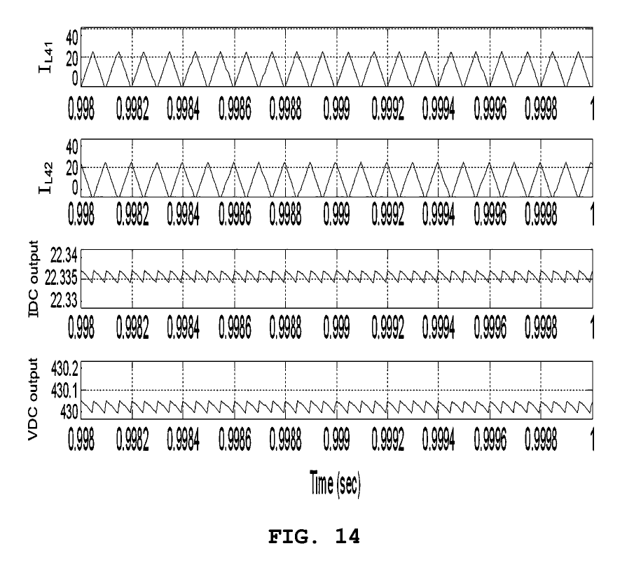

FIG. 14 is a waveform of DC-link output current and voltage in the constant current mode of one-step battery charging module according to an embodiment of the present invention. It can be confirmed that, in the case where the battery charging unit 140 shown in FIG. 3 is constituted by one-step battery charging module, when the first switch SW41 and second switch SW42 in the two bidirectional converters 410 and 420 shown in FIG. 4 are alternately turned on in the constant current mode, reactor current IL41 and IL42 flowing through two reactors in the constant current mode has a phase difference of 180 degrees, and the ripple components of DC output current “IDC output” and DC output voltage “VDC output” are reduced even in the constant current mode.

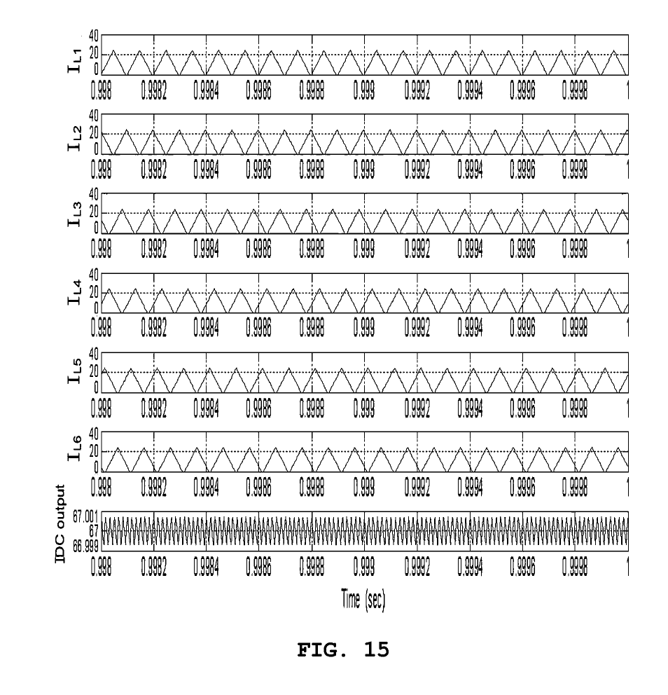

FIG. 15 is a waveform of DC-link output current and voltage in the constant current mode of three-step battery charging modules according to another embodiment of the present invention. In the case where the battery charging unit 140 shown in FIG. 3 is constituted by three-step battery charging modules, and each battery charging module includes two switches, when six individual switches are sequentially turned on with a phase difference of 60 degrees, current flowing through a reactor connected to the output side of each switch in the constant current mode has a phase difference of 60 degrees, and the ripple component of compound DC output current “IDC output” is significantly reduced. Here, “IL1” and “IL2” represent current flowing through the respective reactors of a battery charging module 140-1, “IL3” and “IL4” represent current flowing through the respective reactors of a battery charging module 140-2, and “IL5” and “IL6” represent current flowing through the respective reactors of a battery charging module 140-3.

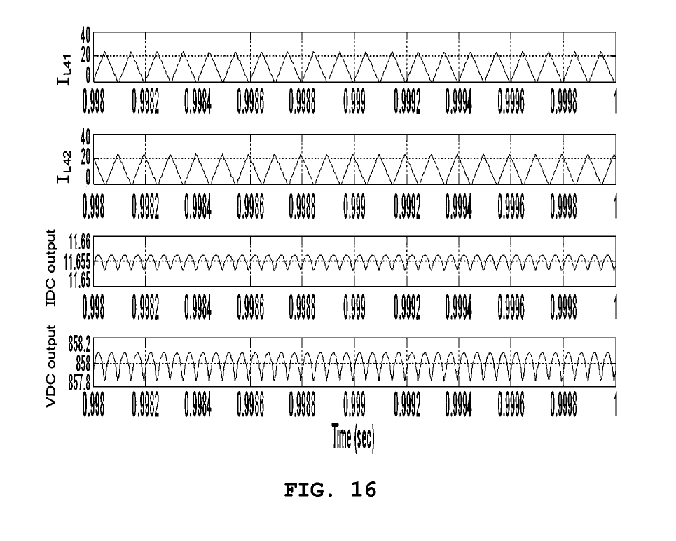

FIG. 16 is a waveform of DC-link output current and voltage in the constant voltage mode of one-step battery charging module according to an embodiment of the present invention. It can be confirmed that, in the case where the battery charging unit 140 shown in FIG. 3 is constituted by one-step battery charging module, when the first switch SW41 and second switch SW42 in the two bidirectional converters 410 and 420 shown in FIG. 4 are alternately turned on in the constant voltage mode, reactor current IL41 and IL42 flowing through two reactors in the constant current mode has a phase difference of 180 degrees, and the ripple components of DC output current “IDC output” and DC output voltage “VDC output” are reduced even in the constant voltage mode.

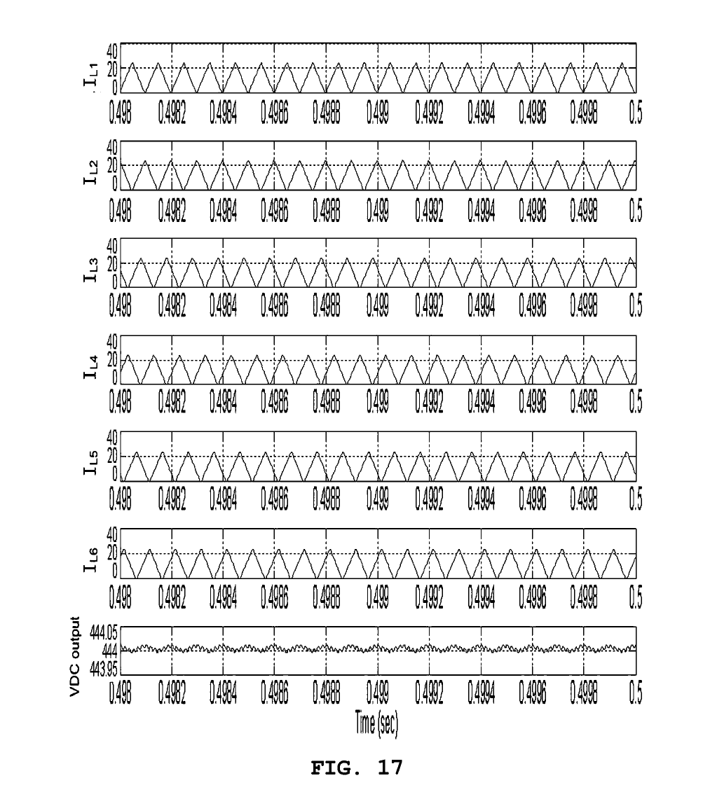

FIG. 17 is a waveform of DC-link output current and voltage in the constant voltage mode of three-step battery charging modules according to another embodiment of the present invention. In the case where the battery charging unit 140 shown in FIG. 3 is constituted by three-step battery charging modules, and each battery charging module includes two switches, when six individual switches are sequentially turned on with a phase difference of 60 degrees, current flowing through a reactor connected to the output side of each switch in the constant voltage mode has a phase difference of 60 degrees, and the ripple component of the DC output voltage “VDC output” is significantly reduced. Here, “IL1” and “IL2” represent current flowing through the respective reactors of a battery charging module 140-1, “IL3” and “IL4” represent current flowing through the respective reactors of a battery charging module 140-2, and “IL5” and “IL6” represent current flowing through the respective reactors of a battery charging module 140-3.

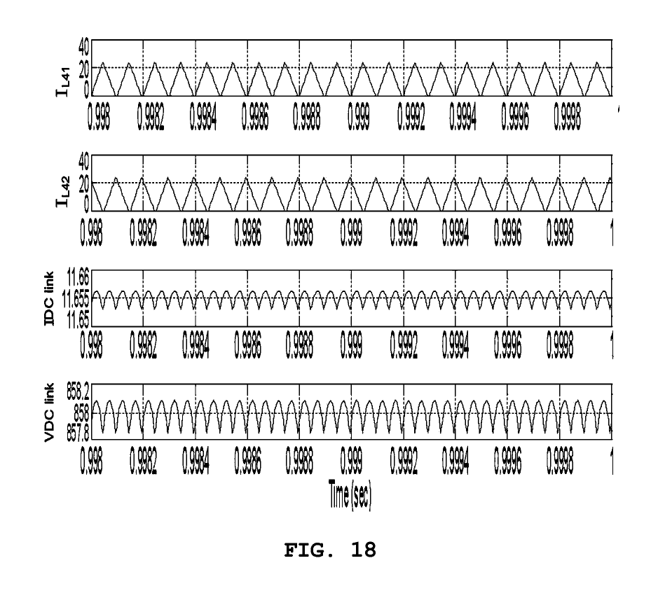

FIG. 18 is a waveform of DC-link output current and voltage in a discharging mode of one-step battery charging module according to an embodiment of the present invention. It can be confirmed that, in the case where the battery charging unit 140 shown in FIG. 3 is constituted by one-step battery charging module, when the first switch SW41 and second switch SW42 in the two bidirectional converters 410 and 420 shown in FIG. 4 are alternately turned on in the discharging mode, reactor current IL41 and IL42 flowing through two reactors in the discharging mode has a phase difference of 180 degrees, and the ripple components of DC output current “IDC output” and DC output voltage “VDC output” are reduced even in the discharging mode.

In this case, when the discharging is performed from the battery unit to the DC link unit, it is preferable to perform a constant current discharging in order to improve the lifetime and safety of the battery.

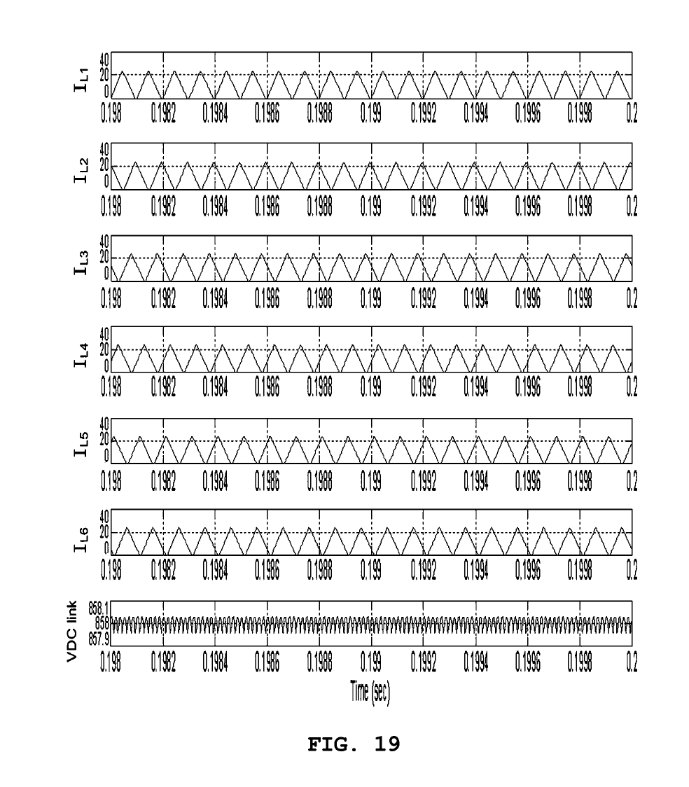

FIG. 19 is a waveform of DC-link output current and voltage in the discharging mode of three-step battery charging modules according to another embodiment of the present invention. In the case where the battery charging unit 140 shown in FIG. 3 is constituted by three-step battery charging modules, and each battery charging module includes two switches, when six individual switches are sequentially turned on with a phase difference of 60 degrees, current flowing through a reactor connected to the output side of each switch in the discharging mode has a phase difference of 60 degrees, and the ripple component of the DC output voltage “VDC output” is significantly reduced. Here, “IL1” and “IL2” represent current flowing through the respective reactors of a battery charging module 140-1, “IL3” and “IL4” represent current flowing through the respective reactors of a battery charging module 140-2, and “IL5” and “IL6” represent current flowing through the respective reactors of a battery charging module 140-3.

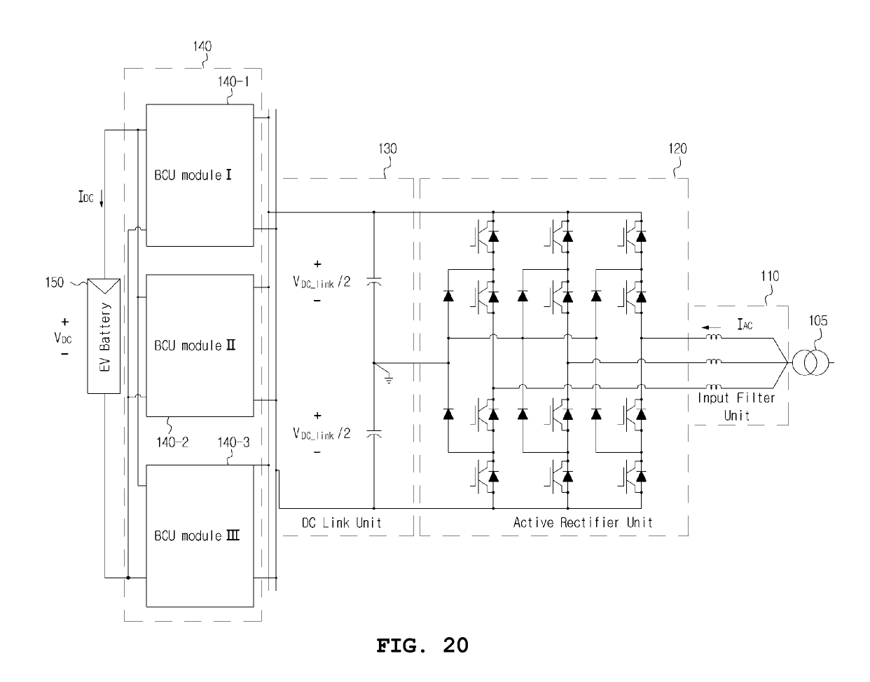

FIG. 20 is a block diagram illustrating the entire configuration of a power supply for boosting charge according to another embodiment of the present invention, wherein one battery charging module is additionally connected in parallel within the battery charging unit 140.

According to the present invention, simply adding the number of battery charging modules connected in parallel with each other makes it possible to reduce the current burden of each module, and enables the charging capacity of the battery to increase.

As is apparent from the above description, the present invention provides a power supply for boosting charge, each part of which is modularized, so that it is possible to simply increase the capacity of the power supply for boosting charge by adding one or more modules.

In addition, according to the present invention, a transformer is installed at a grid side, thereby facilitating insulation between the grid and the power supply for boosting charge, and making it possible to achieve modularization.

In addition, according to the present invention, a phase staggering scheme is applied, thereby making it possible to reduce the ripple of output current.

In addition, according to the present invention, it is possible to reduce the ripple component of output current in the respective charging modes which are different depending on the voltage conditions to a battery, which is profitable for boosting charge of batteries for electric vehicles.

Although preferred embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. A power supply for boosting charge comprising:
an input filter unit configured to filter current or voltage introduced from a power grid;
a rectifying unit configured to rectify an alternating current (AC) voltage outputted from the input filter unit into a direct current (DC) voltage;
a DC link unit configured to smooth an output voltage of the rectifying unit; and
a battery charging unit which includes a battery charging module connected in parallel to the DC link unit.

2. The power supply according to claim 1, further comprising a transformer which is installed at an input terminal of the input filter unit.

3. The power supply according to claim 1, wherein the battery charging module includes a plurality of switching elements connected in parallel with each other, and the plurality of switching elements are alternately switched.

4. The power supply according to claim 1, wherein the battery charging unit performs a charging operation in different modes depending on a charged state of a battery unit.

5. The power supply according to claim 4, wherein the battery charging unit performs the charging operation in a precharge mode when the charged voltage of the battery unit is equal to or less than a first level, in a constant current mode when the charged voltage of the battery unit exceeds the first level and is equal to or less than a second level, and in a constant voltage mode when the charged voltage of the battery unit exceeds the second level.

6. The power supply according to claim 4, wherein the battery charging unit includes a plurality of battery charging modules, and in the precharge mode, any one of the plurality of battery charging modules in the battery charging unit operates.

7. The power supply according to claim 4, wherein the battery charging unit includes a plurality of battery charging modules, and switching elements of the plurality of battery charging modules in the battery charging unit are alternately turned on for an equal period of time within one cycle.

8. The power supply according to claim 1, wherein the battery charging module corresponds to a bidirectional converter which can charge a battery unit from the DC link unit and discharge the battery unit to the DC link unit.

9. The power supply according to claim 5, wherein, in the precharge mode, the battery charging unit controls charging current with step waveform current.

10. The power supply according to claim 5, wherein, in the precharge mode, the battery charging unit controls charging current with low current of a predetermined level.

11. The power supply according to claim 5, wherein, in the precharge mode, the battery charging unit controls charging current with a pulse waveform.

12. The power supply according to claim 8, wherein a discharging from the battery unit to the DC link unit is performed by a constant current discharging.
